(19) United States
(12) Patent Application Publication
(10) Pub. No.: US 2026/0213286 A1
(43) Pub. Date: Jul. 23, 2026

(54) INTEGRATED BATTERY SENSOR AND ACTUATOR

(71) Applicant: GM Global Technology Operations LLC, Detroit, MI (US)

(72) Inventors: Jing GAO, Rochester, MI (US); Xingcheng Xiao, Troy, MI (US); Brian J. Koch, Berkley, MI (US); Jason Graetz, Calabasas, CA (US); Russell Patrick Mott, Agoura Hills, CA (US); Jason Lipton, Los Angeles, CA (US)

(21) Appl. No.: 19/032,775

(22) Filed: Jan. 21, 2025

(51) Int. Cl. H01M 10/42; H01M 50/105; H01M 50/46

(52) U.S. Cl. CPC H01M 10/4257; H01M 50/105; H01M 50/46; H01M 2010/4271; H01M 2010/4278

(57) ABSTRACT

A battery cell includes a battery cell stack including C cathode electrodes including a cathode active material layer arranged on one or both sides of a cathode current collector, A anode electrodes including an anode active material layer arranged on one or both sides of an anode current collector, and S separators, where C, A, and S are integers greater than one. An enclosure surrounds the battery cell stack. A piezoelectric device performing at least one of a sensing and an actuating is arranged in the enclosure and configured to at least one of generate a sensed signal and generate an acoustic signal in response to an applied signal. The piezoelectric device includes a piezoelectric layer made of a fluoropolymer, a first metal layer arranged on one side of the piezoelectric layer, and a second metal layer arranged on an opposite side of the piezoelectric layer.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a fluoropolymer-based piezoelectric sensor/actuator arranged inside an enclosure of a battery cell.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes a battery cell stack including C cathode electrodes including a cathode active material layer arranged on one or both sides of a cathode current collector, A anode electrodes including an anode active material layer arranged on one or both sides of an anode current collector, and S separators, where C, A, and S are integers greater than one. An enclosure surrounds the battery cell stack. A piezoelectric device performing at least one of a sensing and an actuating is arranged in the enclosure and configured to at least one of generate a sensed signal and generate an acoustic signal in response to an applied signal.

In other features, the piezoelectric device includes a piezoelectric layer made of a fluoropolymer, a first metal layer arranged on one side of the piezoelectric layer, and a second metal layer arranged on an opposite side of the piezoelectric layer. The piezoelectric layer includes projections to provide interdigitated contact. The fluoropolymer includes polyvinylidene fluoride (PVDF). The piezoelectric device includes an adhesive layer arranged on one side thereof.

In other features, the piezoelectric device is configured to measure the sensed signal and generate the acoustic signal in response to the applied signal. The sensed signal includes a piezoelectric voltage. The sensed signal includes an acoustic signal. The piezoelectric device is arranged one of between one of the S separators and the enclosure, between one of the S separators and one of the C cathode electrodes, and between one of the S separators and one of the A anode electrodes.

In other features, the enclosure comprises a pouch enclosure or a rigid enclosure.

A battery cell includes a battery cell stack including C cathode electrodes including a cathode active material layer arranged on one or both sides of a cathode current collector, A anode electrodes including an anode active material layer arranged on one or both sides of an anode current collector, S separators, where C, A, and S are integers greater than one. An enclosure surrounds the battery cell stack. A piezoelectric device performs at least one of sensing and actuating and includes a fluoropolymer layer, a first metal layer arranged on one side of the fluoropolymer layer, and a second metal layer arranged on an opposite side of the fluoropolymer layer. The piezoelectric device is configured to at least one of generate a sensed signal and output an acoustic signal in response to an applied signal.

In other features, the piezoelectric device is arranged in the enclosure between the battery cell stack and an inner surface of the enclosure. The piezoelectric device includes an adhesive layer arranged on one side thereof to attach the piezoelectric device to one of the S separators. The fluoropolymer layer includes polyvinylidene fluoride (PVDF).The piezoelectric device is configured to measure the sensed signal and generate the acoustic signal in response to the applied signal. The sensed signal includes a piezoelectric voltage. The sensed signal includes an acoustic signal. The enclosure comprises one of a pouch enclosure and a rigid enclosure.

A battery cell comprises a battery cell stack including C cathode electrodes including a cathode active material layer arranged on one or both sides of a cathode current collector, A anode electrodes including an anode active material layer arranged on one or both sides of an anode current collector, and S separators, where C, A, and S are integers greater than one. An enclosure surrounds the battery cell stack. A piezoelectric device includes a polyvinylidene fluoride (PVDF) layer, a first metal layer arranged on one side of the PVDF layer, a second metal layer arranged on an opposite side of the PVDF layer, and an adhesive layer arranged on one side thereof to attach the piezoelectric device to one of the S separators. The piezoelectric device is configured to generate a sensed signal and output an acoustic signal in response to an applied signal. The piezoelectric device is attached to an outer surface of the battery cell stack between the battery cell stack and an inner surface of the enclosure.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a battery cell including C cathode electrodes, A anode electrodes, S separators, and a fluoropolymer-based piezoelectric sensor according to the present disclosure;

FIGS. 2A and 2B are perspective views of an example of a fluoropolymer-based piezoelectric sensor attached to a separator layer according to the present disclosure;

FIG. 3 is a functional block diagram of a system for monitoring a sensed parameter of a battery cell using the fluoropolymer-based piezoelectric sensor and/or generating acoustic signals using the fluoropolymer-based piezoelectric sensor according to the present disclosure;

FIG. 4 is a graph illustrating current, voltage, and acoustic signals of a battery cell; and

FIGS. 5 and 6 are examples of monitoring of the battery cell using the fluoropolymer-based piezoelectric sensor and other sensors.

In the drawings, reference numbers may be reused to identify similar and/or identical elements.

### DETAILED DESCRIPTION

While the battery cells are described herein in the context of vehicles, the battery cells can be used in other mobile applications and/or stationary applications.

Real-time battery monitoring and advanced diagnostic systems are important for electric vehicles (EVs). Detecting pressure changes and thermal runaway in EV batteries is challenging. For example, prismatic and cylindric cells use rigid enclosures, dense packaging, and intricate battery cell arrangements that make temperature spikes difficult to detect at their onset using external sensors. Additionally, internal defects or latent manufacturing flaws may not manifest immediately, which leads to unexpected events and/or rapid overheating.

Placement of sensors within the battery cells improves detection performance. The present disclosure relates to a fluoropolymer-based piezoelectric sensor/actuator that is arranged inside of an enclosure of a battery cell. Fluoropolymers are fluorocarbon based polymers with multiple carbon fluorine bonds. The piezoelectric sensor uses piezoelectric fluoropolymers that are stable in the harsh lithium-ion cell environment. In some examples, voltage and/or acoustic signals generated by the piezoelectric sensor enable sensing and diagnosis of mechanical degradation and/or enable mechanical degradation to be correlated with battery life.

A battery monitoring system including the piezoelectric sensor can be used by engineering teams during development to optimize battery cell design with improved cycling stability and/or to achieve fast charging with improved safety. The piezoelectric sensors can also be deployed in production vehicles to prolong the lifetime of the battery system and/or to increase safety.

Sensors that are currently arranged inside the battery packs include voltage, current, and temperature sensors. These sensing methods are lacking in direct measurement value, and instead rely on information which can be related via algorithm to estimate state of health (SoH), state of charge (SoC), and/or internal short circuits.

Acoustic sensing can provide additional diagnostic information that is not available from voltage, current, and/or temperature sensing such as gas evolution and internal short circuiting. Rigid ceramic piezoelectric actuators that are coated in a protective layer have been used to generate ultrasound signals to induce and stimulate ion flux within the electrolyte and to prevent dendrite formation at higher current rates. However, the ceramic piezoelectric actuators were not used for sensing. In addition, the form factor of the ceramic piezoelectric actuators is difficult to integrated inside of the enclosure of the battery cell. The fluorocarbon-based piezoelectric sensor/actuators are flexible and thin (e.g., 0.5 mm to 3 mm).

Referring now to FIG. 1, a battery cell 10 includes C cathode electrodes 20, A anode electrodes 40, and S separators 32 arranged in a predetermined sequence in a battery cell stack 12, where C, S and A are integers greater than zero. In some examples, the vehicle 11 includes a battery module or pack 13 including the battery cell 10. The battery cell stack 12 is arranged in an enclosure 50. In some examples, the enclosure 50 is rigid such as a prismatic enclosure, a cylindrical enclosure, or a coin cell or a flexible enclosure such as a pouch enclosure.

In some examples, a liquid electrolyte 52 is used. In some examples, the liquid electrolyte includes an organic solvent with dissolved ions. In other examples, a solid electrolyte is used. In some examples, the S separators 32 include a porous thermoplastic material with or without a ceramic coating.

The C cathode electrodes 20-1, 20-2, ..., and 20-C include a cathode active material layer 24 arranged on one or both sides of a cathode current collector 26. In some examples, the cathode active material layer includes a cathode active material (e.g., a metal oxide, a metal fluoride, sulfur, a metal phosphate, etc.), a conductive filler such as conductive carbon, and a binder, although other materials can be used. The A anode electrodes 40-1, 40-2, ..., and 40-A include an anode active material layer 42 arranged one or both sides of an anode current collector 46. In some examples, the anode active material layer includes an anode active material (e.g., graphite, silicon, a metal layer, a metal particle, hard carbon, etc.), a conductive filler such as conductive carbon, and a binder, although other materials can be used.

During charging/discharging, the A anode electrodes 40 and the C cathode electrodes 20 exchange lithium ions. In some examples, the cathode active material layers 24 and/or anode active material layers 42 comprise coatings that are applied to the cathode current collectors 26 and/or anode current collectors 46.

In some examples, the cathode current collectors 26 and/or the anode current collectors 46 comprise metal foil, metal mesh, perforated metal, 3 dimensional (3D) metal foam, and/or expanded metal. External tabs 28 and 48 are connected to the cathode current collectors 26 and/or anode current collectors 46, respectively, and can be arranged on the same or different sides of the battery cell stack 12. The external tabs 28 and 48 are connected to positive and negative battery tabs.

In FIG. 1, a piezoelectric device 60 is shown in various locations inside of the enclosure 50. In some examples, the piezoelectric device 60 includes a piezoelectric sensor or piezoelectric actuator. In other examples, the piezoelectric device 60 includes both a piezoelectric sensor and a piezoelectric actuator. In still other examples, the piezoelectric device 60 includes a single piezoelectric device performing both sensing and actuating functions.

In some examples, the piezoelectric device 60 is arranged on an outer surface of the battery cell stack 12 adjacent to the enclosure 50. In some examples, the piezoelectric device 60 is in the form of tape and includes a fluoropolymer layer, first and second metal layers arranged on opposite sides thereof, and an adhesive layer to adhere the piezoelectric device 60 to an outermost one of the S separators 32. In some examples, the fluoropolymer includes polyvinylidene fluoride (PVDF). In other examples, the piezoelectric device 60 is attached, embedded or freestanding in between one of the S separators and one of the C cathode electrodes 20 or A anode electrodes 40.

In some examples, the piezoelectric device 60 is configured to detect pressure changes in the battery cell. In some examples, the piezoelectric device 60 is configured to detect conformational changes in the battery cell stack (e.g., changes in the shape of a macromolecule, often induced by environmental factors). The battery cell stack can expand if there is gas evolution from the electrodes or electrolyte, which causes swelling of the battery cell stack. The swelling of the battery cell stack results in a voltage change in the piezoelectric device 60 surrounding the battery cell stack. The gas evolution can happen as a result of overheating in thermal runaway. In some examples, the piezoelectric device 60 is configured to detect acoustic signals in the battery cell caused by gas evolution from the cathode electrode.

In some examples, the piezoelectric device 60 is configured to detect ultrasound acoustic signals produced by an external acoustic source to estimate battery state of charge (SOC), state of health (SOC), or other metrics based thereon.

In some examples, the piezoelectric device 60 is configured to act as an actuator and to vibrate with applied voltage to reduce or prevent internal short circuiting of the battery cell by reducing dendrite formation and/or buildup. In other words, the vibration can be used to break up the dendrites or prevent formation of dendrites. In some examples, the piezoelectric device 60 is configured to vibrate with an applied voltage to stimulate ion flux and facilitate charge transfer for fast charging.

In some examples, the piezoelectric device 60 has a planar shape. In some examples, the piezoelectric device 60 includes a roughened surface including projections to provide interdigitated contact to vary modes of vibration.

In some examples, the piezoelectric device 60 is connected by conductors such as metal layers to a location outside of the battery cell. In some examples, the contacts are integrated into another component of the battery cell, such as the pouch material or current collector.

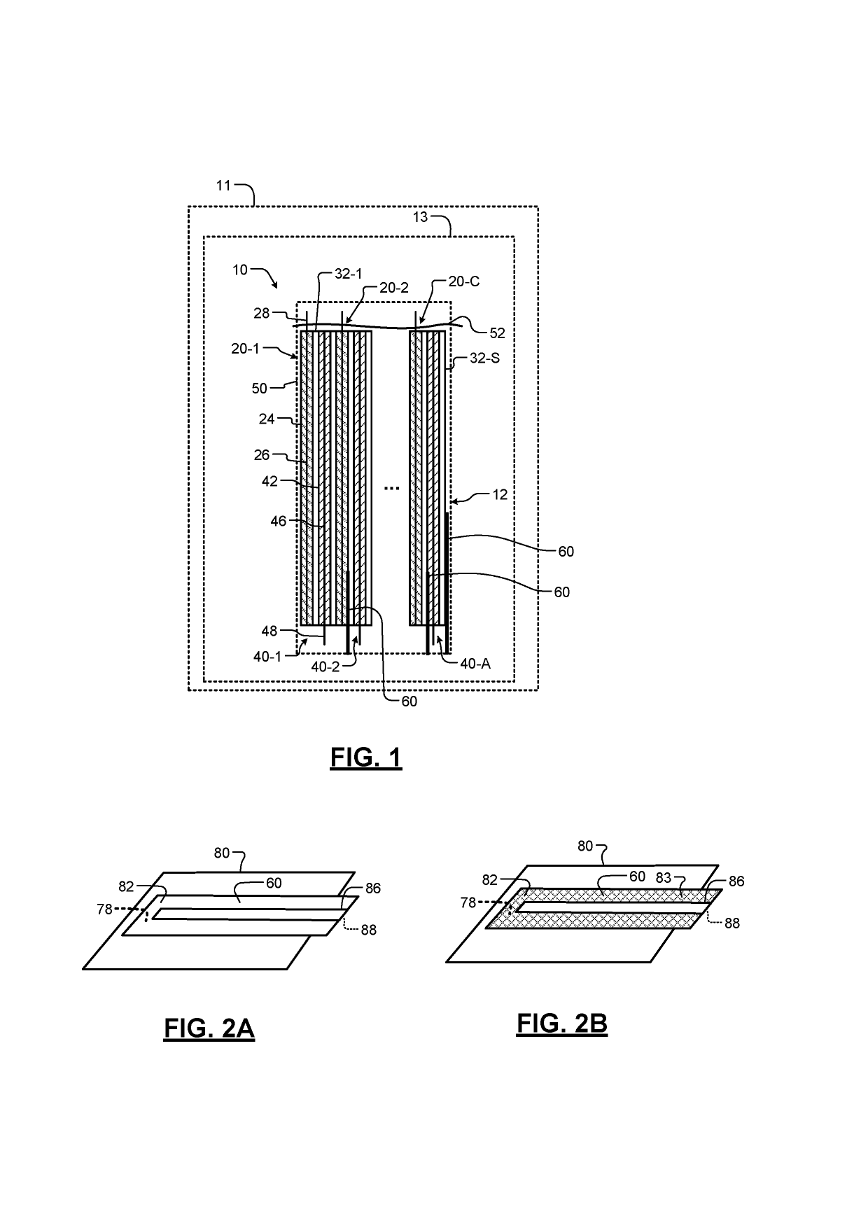

Referring now to FIGS. 2A and 2B, the piezoelectric device 60 includes a fluoropolymer layer 82 including metal layers 86 and 88 arranged on opposite surfaces thereof. In FIG. 2A, the fluoropolymer layer 82 is generally planar. In FIG. 2B, the fluoropolymer layer 82 includes projections 83 to provide interdigitated contact. An adhesive layer 78 arranged on a bottom surface of the piezoelectric device 60 attaches the piezoelectric device 60 to a surface 80 of another battery cell component (such as one of the A anode electrodes, one of the C cathode electrodes, one of the S separators, and/or on an inner surface of the enclosure 50). Metal layers 86 and 88 arranged on opposite sides of the fluoropolymer layer 82 act as conductors to sense a voltage across the piezoelectric device 60 and/or acoustic signals generated by the piezoelectric device 60. When the metal layers 86 and 88 are driven by an external voltage, the piezoelectric device 60 generates acoustic signals.

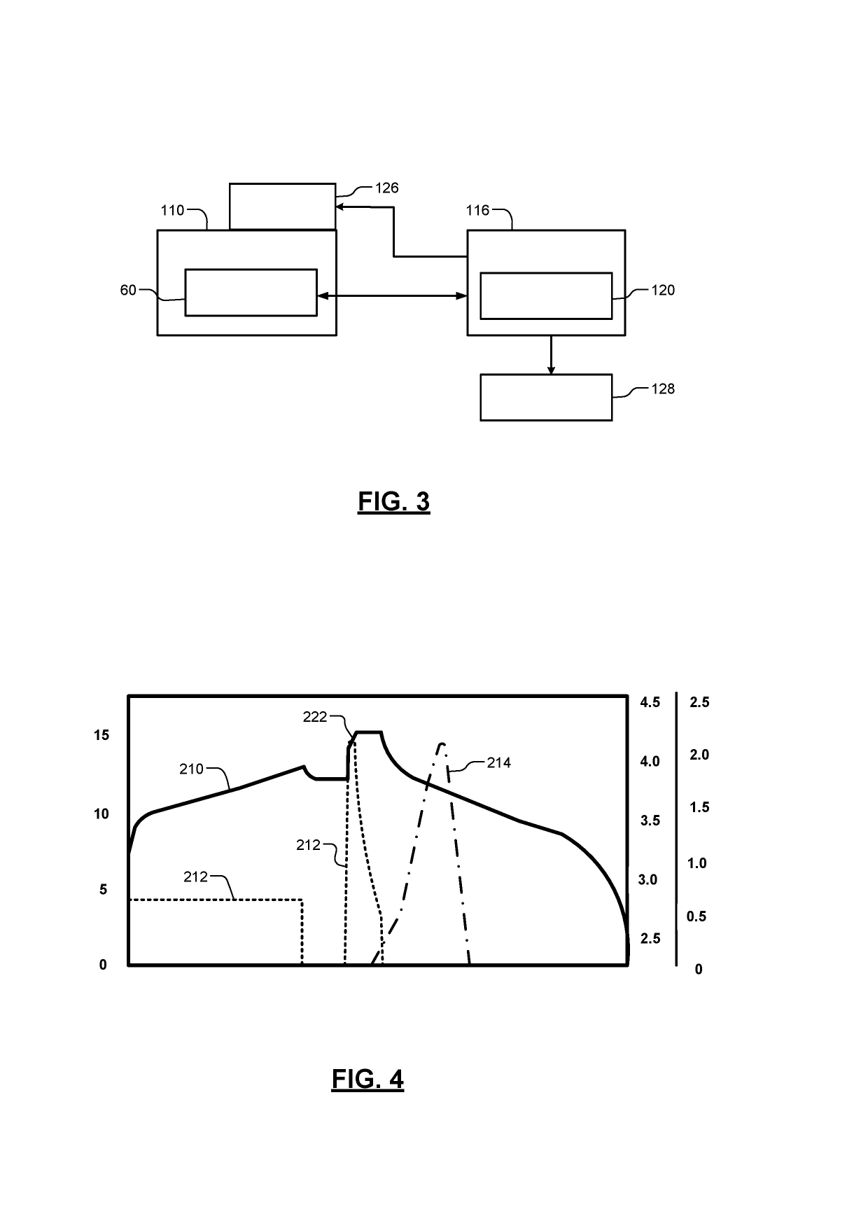

Referring now to FIG. 3, the piezoelectric device 60 is arranged inside of the enclosure of a battery cell 110. A controller 116 located outside of the battery cell 110 includes a diagnostic/driver module 120 configured to receive signals sensed by the piezoelectric device 60 and/or to generate acoustic signals by applying an external voltage.

In some examples, the diagnostic/driver module 120 supplies power to an acoustic source 126 located outside of the battery cell 110 to generate external acoustic signals and measures resulting acoustic signals inside of the battery cell using the piezoelectric device 60. In some examples, the controller 116 is configured to diagnose a malfunctioning battery cell in response to the measured parameters and to generate an alert signal. In some examples, the alert signal includes setting a diagnostic flag, generating an audio signal, and/or generating a visual signal using a user interface (UI)/display 128.

Referring now to FIG. 4, piezoelectric voltage 210, battery cell current 212, and an acoustic signal 214 are shown as a function of time. A large number of acoustic emission hits are detected when cell voltage is increased to 4.2 volts (V) at 75% charge. The current includes a large charging current (~2C). As can be appreciated, the piezoelectric device 60 can be used to detect changes in battery cell operation.

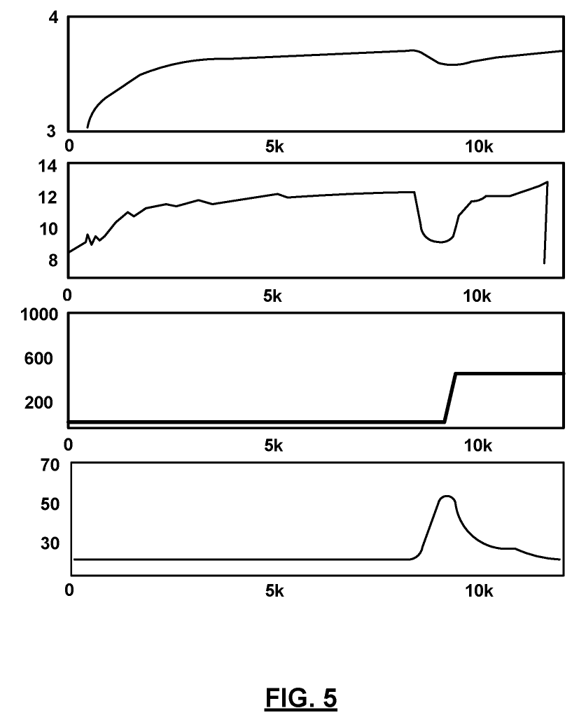

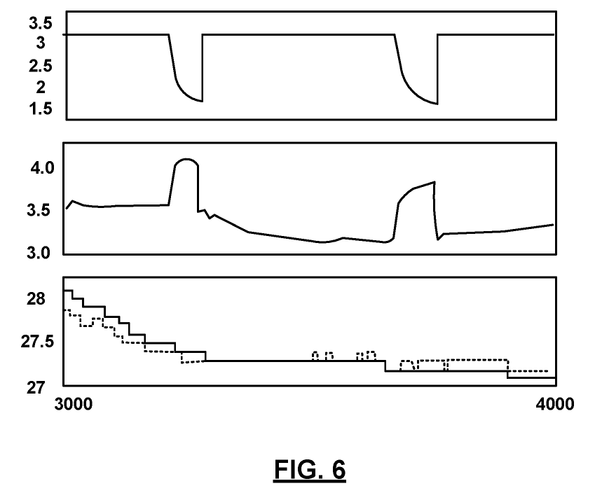

Referring now to FIGS. 5 and 6, monitored parameters of the battery cell are shown as a function of time. In FIG. 5, battery cell voltage, piezoelectric voltage, acoustic hits, and battery cell temperature are shown as a function of time. In FIG. 6, battery cell voltage, piezoelectric voltage, and battery cell temperature are shown as a function of time during an internal short circuit. Internal short circuits may occur during fast charging and can lead to thermal runaway. To cause an external short when desired, a metal piece having a low melting point is embedded inside of the battery cell and the battery cell is heated to cause the metal piece to melt (causing a short between the anode and cathode electrode). This causes the spike down in cell voltage. The sudden release of energy locally also causes a change in morphology of the battery cell stack, which in turn results in a voltage change in the piezoelectric sensor/actuator.

In both examples, piezoelectric voltage and/or acoustic hits sensed by the piezoelectric sensor are able to detect unusual behavior more quickly and with more dramatic changes than cell voltage and temperature signals.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A battery cell comprising:
a battery cell stack including:
C cathode electrodes including a cathode active material layer arranged on one or both sides of a cathode current collector;
A anode electrodes including an anode active material layer arranged on one or both sides of an anode current collector;
S separators, where C, A, and S are integers greater than one; and
an enclosure surrounding the battery cell stack; and
a piezoelectric device performing at least one of sensing and actuating, arranged in the enclosure, and configured to at least one of generate a sensed signal and generate an acoustic signal in response to an applied signal.

2. The battery cell of claim 1, wherein the piezoelectric device includes:
a piezoelectric layer made of a fluoropolymer;
a first metal layer arranged on one side of the piezoelectric layer; and
a second metal layer arranged on an opposite side of the piezoelectric layer.

3. The battery cell of claim 2, wherein the piezoelectric layer includes projections to provide interdigitated contact.

4. The battery cell of claim 2, wherein the fluoropolymer includes polyvinylidene fluoride (PVDF).

5. The battery cell of claim 2, wherein the piezoelectric device includes an adhesive layer arranged on one side thereof.

6. The battery cell of claim 1, wherein the piezoelectric device is configured to measure the sensed signal and generate the acoustic signal in response to the applied signal.

7. The battery cell of claim 6, wherein the sensed signal includes a piezoelectric voltage.

8. The battery cell of claim 6, wherein the sensed signal includes an acoustic signal.

9. The battery cell of claim 1, wherein the piezoelectric device is arranged one of:
between one of the S separators and the enclosure;
between one of the S separators and one of the C cathode electrodes; and
between one of the S separators and one of the A anode electrodes.

10. The battery cell of claim 1, wherein the enclosure comprises a pouch enclosure.

11. The battery cell of claim 1, wherein the enclosure comprises a rigid enclosure.

12. A battery cell comprising:
a battery cell stack including:
C cathode electrodes including a cathode active material layer arranged on one or both sides of a cathode current collector;
A anode electrodes including an anode active material layer arranged on one or both sides of an anode current collector;
S separators, where C, A, and S are integers greater than one;
an enclosure surrounding the battery cell stack; and
a piezoelectric device performing at least one of sensing and actuating and including:
a fluoropolymer layer;
a first metal layer arranged on one side of the fluoropolymer layer; and
a second metal layer arranged on an opposite side of the fluoropolymer layer, wherein the piezoelectric device is configured to at least one of generate a sensed signal and output an acoustic signal in response to an applied signal.

13. The battery cell of claim 12, wherein the piezoelectric device is arranged in the enclosure between the battery cell stack and an inner surface of the enclosure.

14. The battery cell of claim 12, wherein the piezoelectric device includes an adhesive layer arranged on one side thereof to attach the piezoelectric device to one of the S separators.

15. The battery cell of claim 12, wherein the fluoropolymer layer includes polyvinylidene fluoride (PVDF).

16. The battery cell of claim 12, wherein the piezoelectric device is configured to measure the sensed signal and generate the acoustic signal in response to the applied signal.

17. The battery cell of claim 16, wherein the sensed signal includes a piezoelectric voltage.

18. The battery cell of claim 16, wherein the sensed signal includes an acoustic signal.

19. The battery cell of claim 12, wherein the enclosure comprises one of a pouch enclosure and a rigid enclosure.

20. A battery cell comprising:
a battery cell stack including:
C cathode electrodes including a cathode active material layer arranged on one or both sides of a cathode current collector;
A anode electrodes including an anode active material layer arranged on one or both sides of an anode current collector;
S separators, where C, A, and S are integers greater than one;
an enclosure surrounding the battery cell stack; and
a piezoelectric device including:
a polyvinylidene fluoride (PVDF) layer;
a first metal layer arranged on one side of the PVDF layer;
a second metal layer arranged on an opposite side of the PVDF layer; and
an adhesive layer arranged on one side thereof to attach the piezoelectric device to one of the S separators,
wherein the piezoelectric device is configured to generate a sensed signal and output an acoustic signal in response to an applied signal, and
wherein the piezoelectric device is attached to an outer surface of the battery cell stack between the battery cell stack and an inner surface of the enclosure.
